(19) United States
(12) Patent Application Publication
(10) Pub. No.: US 2024/0339755 A1
(43) Pub. Date: Oct. 10, 2024

(54) WINDING CARRIER, ANTENNA, AND METHOD FOR MANUFACTURING AN ANTENNA

(71) Applicant: Schaffner EMV AG, Luterbach (CH)

(72) Inventors: Roberto Mrad, Zuchwil (CH); Benedikt Othmar Scheller, Luterbach (CH)

(73) Assignee: Schaffner EMV AG, Luterbach (CH)

(21) Appl. No.: 18/613,061

(22) Filed: Mar. 21, 2024

(30) Foreign Application Priority Data
Apr. 5, 2023 (EP) 23166758.5

(51) Int. Cl. H01Q 7/08; H01Q 1/12

(52) U.S. Cl. CPC H01Q 7/08; H01Q 1/12

(57) ABSTRACT

The invention relates to a winding carrier for receiving windings of a coil and housing a magnetic core of an antenna, the winding carrier comprises:
a main carrier member extending along a longitudinal axis (x) between a first end and
a second end opposite the first end; and
an accessory carrier member movably engaged with the main carrier member, wherein the main carrier member and the accessory carrier member each is configured to hold a multitude of windings, wherein the main carrier member and the accessory carrier member are configured complementary to each other for guiding a movement of the accessory carrier member along the longitudinal axis (x) for positioning the accessory carrier member between an initial position and an end position.

The invention further relates to an antenna and a method for manufacturing an antenna.

### REFERENCE DATA

This patent application claims priority of European patent application EP23166758.5 of Apr. 5, 2023 to Schaffner EMV AG, the contents whereof are hereby entirely incorporated by reference.

### TECHNICAL DOMAIN

The present invention concerns a winding carrier, an antenna and a method for manufacturing and adjusting an inductance of an antenna.

### RELATED ART

Antennas generally consist of a ferromagnetic core and a coil and are usually potted in a housing. Depending on the transmission frequency and the bandwidth, the core and the coil must be correspondingly designed. The bandwidths of antennas are becoming ever wider, for example for UWB antennas, and the range of the antenna is becoming ever greater, which has the consequence, for example, that the cores are also becoming ever longer. Antennas used, for instance, in keyless entry systems, such as those used in automotive applications, typically work in concert with a capacitor to form a resonant circuit. The resonant circuit conventionally needs to be tuned to a specific frequency or bandwidth to be interoperable with a sender/receiver device such as a key. The resonant circuit's tuning can be done by varying the capacitance of the capacitor or by varying the inductance of the antenna. Changing the inductance is often more desirable, as tuning the resonant circuit by varying the capacitance often is associated with high effort and an extensive stock of different capacitors.

Solutions known from the prior art, such as the U.S. Pat. No. 7,372,421B2 allow flexibly adjusting the antenna's inductance during manufacturing. This kind of flexibility also brings disadvantages, in particular with respect to subsequent manufacturing steps, such as the potting of the antenna. Once the inductance has been set, any further variation of the inductance should be prevented. The use of adhesives to prevent changes to the inductance set during production often involves additional effort, which is not desirable for the production of antennas in high volumes. On the other hand, the solutions known from the prior art often require highly skilled manufacturing personnel to adjust the inductance of the antenna according to the specification. Precisely following a protocol for manufacturing the antennas is fault-prone and time-consuming, often not desirable.

### Short Disclosure of the Invention

An aim of the present invention is the provision of a winding carrier, an antenna, and a method for manufacturing and adjusting the inductance of an antenna, each with the objective to overcome the shortcomings and limitations of the state of the art.

According to the first aspect of the present invention, a winding carrier for an antenna is disclosed, involving the features recited in claim 1. Further features and embodiments of winding carrier of the present invention are described in the dependent claims.

The invention relates to the winding carrier for receiving windings of a coil and housing a magnetic core of an antenna, the winding carrier comprises:
a main carrier member extending along a longitudinal axis between a first end and a
second end opposite the first end; and
an accessory carrier member movably engaged with the main carrier member, wherein the main carrier member and the accessory carrier member each is configured to hold a multitude of windings, wherein the main carrier member and the accessory carrier member are configured complementary to each other for guiding a movement of the accessory carrier member along the longitudinal axis for positioning the accessory carrier member between an initial position and an end position. Winding can by synonym for turn of a winding.

Alternatively, the accessory carrier member can be configured for being movably positioned between an initial position and an end position, wherein the main carrier member can be arranged for guiding a movement along the longitudinal axis for positioning the accessory carrier member.

Sometimes, the winding carrier is also called core support, bobbin, or antenna winding carrier, whereby the terms might be used interchangeably during the present disclosure. In principle, the winding carrier comprises a main carrier member and an accessory carrier member. The main carrier member can be configured with an inner volume for receiving and housing magnetic cores. The windings can be wound around the main carrier and accessory carrier members. However, the magnetic cores and the coil are not part of the winding carrier.

As indicated, the accessory carrier member can be movably engaged with the main carrier member such that it can be moved between two extreme positions along the longitudinal axis. The accessory carrier member can be carried by and movably fixated to the main carrier member. The longitudinal axis can be the axis of symmetry running from the first end to the second end through the center of the winding carrier.

The expression “configured complementary to each other” refers to the fact that the main carrier member and the accessory carrier member each can be configured to work in concert to provide a specific function, namely guiding the movement of the accessory carrier member. Therefore, the main carrier member and the accessory carrier member complement each other in their functioning, comparable to a plug and a socket. It needs to be stressed that the main carrier member and the accessory carrier member are configured to mechanically complement each other to provide the mechanical function.

Suppose the main carrier member and the accessory carrier are carrying windings. In that case, the windings carried by the accessory carrier member can be displaced or variably positioned along the longitudinal axis. The accessory carrier member enables the displacement as being movably engaged with the main carrier member. This is advantageous since the accessory carrier member enables the adjustment of the inductance of an antenna, which will be explained in more detail in the course of the present disclosure. Furthermore, since the movement of the accessory carrier member along the longitudinal axis is guided, the inductance can be granular and predictably varied.

The main carrier member and the accessory carrier member can be made of the same non-magnetic material, such as plastic. The material used must be compatible with the potting compound if the winding carrier is potted in a final manufacturing step.

The winding carrier as such, which exhibits the features described previously, can be manufactured without high effort and is therefore well suited to be produced in high quantities. Alternatively, or additionally, the winding carrier is suitable for making an antenna with an adjustable inductance.

In a first embodiment of the first aspect of the invention, the main carrier member can comprise two end sections and a middle section provided between the two end sections, wherein the accessory carrier member can be positioned in one of the two end sections, wherein the end section in which the accessory carrier member can be positioned can be closer to the second end than to the first end. Each end section preferably covers less than 32%, preferably less than 25%, most preferably less than 20% of the total length of the main carrier member. The accessory carrier member can preferably be moved in an area of the main carrier member, which comprises less preferably than 30% of the longitudinal extent of the main carrier member. Placing the accessory carrier member at the second end allows using the first end for a different purpose, for instance, providing an inserting section for inserting the magnetic core and/or mechanically fixating a connector. Most preferably, the magnetic core can be inserted at the second end, whereby the main carrier can be configured with a dedicated inserting section, such as an opening, allowing an assembly of the magnetic core.

In a second embodiment of the first aspect of the invention, the main carrier member can be configured with a plurality of end stops for limiting the movement of the accessory carrier member along the longitudinal axis, preferably or exclusively for limiting the movement between the initial position and the end position. The end stops can be provided in the form of protrusions or projections extending from the main carrier member to limit the accessory carrier member's movement between the extreme positions.

In a third embodiment of the first aspect of the invention, the main carrier member can comprise a guiding structure, wherein the accessory carrier member can be configured to embrace the main carrier member and to engage with the guiding structure for guiding the movement along the longitudinal axis and preventing the movement into a different than a longitudinal direction. The longitudinal direction can refer to the direction that runs parallel to the longest axis of the main carrier member. In other terms, it can be the direction that goes from the first end to the second end (or vice versa) following the length of the main carrier member. Therefore, the movement of the accessory carrier member along the longitudinal axis can be linear. Combined with windings of the coil, this can enable a linear adjustment of the inductance of the antenna.

In a further embodiment of the first aspect of the invention, the guiding structure of the main carrier member can be configured as a guide strip and the part of the accessory carrier member engaging with the guiding structure can be configured as a guide claw. The guide strip and the guide claw complement each other in an efficient mechanical manner, relatively simple to manufacture.

In a different embodiment of the first aspect of the invention, the accessory carrier member can comprise a flexible member, and the main carrier member can comprise a structure complementary to the flexible member, wherein the flexible member can be configured to engage with the complementary structure for stepwise position the accessory carrier member between the initial position and the end position.

The flexible member can be configured as a spring member, which can be deformed under an applied force and returns to its original position as soon as the force is released. In the absence of the force the accessory carrier member is reliably held in place, even if the accessory carrier member experiences a buoyancy force or a downward force during potting.

This feature can also enable the accessory carrier member not only to be linearly moved but also to be stepwise linearly moved. When combined with windings, a stepwise adjustment of the inductance of the antenna is possible, which can simplify the manufacturing process of the antenna, as every step might result in a predetermined change of the antenna's inductance. In summary, this feature can result in a two-fold function, namely the stepwise adjustment of the position of the accessory carrier member and the locking of the position of the accessory carrier member.

In another embodiment of the first aspect of the invention, the complementary structure can be configured as a toothed strip comprising a plurality of slots and the flexible member can be configured as a flexible protrusion comprising a nose, wherein the nose can be configured to engage with at least one slot of the plurality of a plurality of slots. Again, the flexible member also can be understood as a spring member, which can reliably lock the position of the accessory carrier member.

In a further embodiment of the first aspect of the invention, the winding carrier can comprise a plurality of protruding spacers, wherein the protruding spacers can be arranged at the second end for centrally position the winding carrier in a housing external to the winding carrier. This embodiment may not be limited to protruding spacers arranged at the second end. Additional protruding spacers can also be placed at a different position of the main carrier member, whereas protruding can refer to the circumstance that the spacers stick out or extends from the main carrier member. The protruding spacers can also be configured as spring members and thus can be flexible.

Even though the individual embodiments of the first aspect cover different aspects of the invention, some or all embodiments can be combined when it is useful and feasible from a technical standpoint.

According to a second aspect of the present invention, an antenna is disclosed.

The antenna comprises:
a coil comprising a multitude of windings arranged in at least two winding sections;
a magnetic core; and
a winding carrier of the first aspect (including any embodiment or a combination thereof), wherein the magnetic core is comprised in an inner volume of the winding carrier and wherein the windings are wound around the winding carrier.

The magnetic core can be assembled from or formed by multiple magnetic core members, such as ferrite bricks or cubes. The material of the magnetic core can be ferrite, such as soft ferrite, specifically selected for the antennas operating frequency band. Conventionally for higher frequency applications, e.g. above 25 MHz, nickel-zinc ferrite is used.

The windings can be specifically wound around the main carrier member and the accessory carrier member so that each member can receive a portion of the windings. The combination of the magnetic core, the winding carrier, and the coil wound around the main carrier member and the accessory carrier member can provide an antenna where the inductance is adjustable simply and conveniently, specifically for antennas produced in high volumes.

In a first embodiment of the second aspect of the invention, the antenna can comprise a first winding section can be wound around the main carrier member and a second winding section can be wound around the accessory carrier member.

In a second embodiment of the second aspect of the invention, the second winding section can comprise more turns per unit area compared to the first winding section. This can be useful, as the accessory carrier member can receive a high amount of windings in a relatively small space, and a large portion of the inductance can be varied as a large amount of windings is displaced. As a rule of thumb, the more windings per unit area the accessory carrier member carries, the higher the change of the inductance can be.

In a third embodiment of the second aspect of the invention, the antenna can comprise a third winding section wound around the main carrier member wherein the third winding section can comprise more turns per unit area compared to the first winding section. The third winding section can be used to mechanically stabilize the main carrier, specifically when positioned at an end opposite the accessory carrier member's position. Furthermore, suppose an inserting section for inserting a magnetic core is provided at the said end. In that case, the third winding section can support fixating the magnetic core inserted into the winding carrier. Most preferably, the third winding section can equilibrate the magnetic field distribution in the magnetic core, such as obtaining a distributed field density across the magnetic core.

In a further embodiment of the second aspect of the invention, the second winding section can be arranged closer to the second end of the winding carrier than to the first end and/or the third winding section can be arranged closer to the first end of the winding carrier than to the second end. In general, when the second winding section is arranged closer to an end of the winding carrier, the change in the inductance of the antenna becomes more significant and more sensitive. The closer the second winding section is to the center, the less sensitive the change in inductance (smaller variation).

Preferably the second winding section can be arranged closer to the second end of the winding carrier than to the first end and the third winding section can be arranged closer to the first end of the winding carrier than to the second end. As indicated before, positioning the third winding section closer to the first end can leave space for providing the winding carrier with an inserting section for inserting the magnetic core.

Even though the individual embodiments of the second aspect cover different aspects of the invention, some or all embodiments can be combined when it is useful and feasible from a technical standpoint.

According to a third aspect of the present invention, a method for manufacturing and adjusting the inductance of an antenna is disclosed. The antenna can comprise the features of the second aspect (including any embodiments or a combination thereof).

The method comprises the steps of:
providing the winding carrier of the first aspect (including any embodiment or a
combination thereof);
inserting a magnetic core into an inner volume of the winding carrier;
positioning the accessory carrier member at an initial position;
forming a coil by winding a dense winding section around the accessory carrier member and winding a sparse winding section around the main carrier member;
clamping an assembly comprising the winding carrier, the magnetic core, and the coil into a testing device;
connecting terminals of the coil to corresponding terminals of the testing device;
measuring an inductance of the assembly with the testing device;
either stepwise moving the accessory carrier member carrying the dense winding section from the initial position along the longitudinal axis until the inductance as measured matches a predetermined inductance value or inductance range or stepwise moving the accessory carrier member carrying the dense winding section from the initial position along the longitudinal axis to a final position, whereby the final position is calculated based on the measurement of the inductance and a predetermined constant.

The manufacturing method as disclosed can be advantageous over manufacturing methods known from the prior art. The manufacturing method is simple and can lead to a production of an antenna where the inductance is reliably set, even when the antenna is produced in the absence of specifically trained manufacturing personnel. On the other hand, and especially with the use of the winding carrier, according to the first aspect, the inductance can be reliably set and locked to a predetermined value.

It is not necessary to directly connect the terminals of the coil to the testing device. The terminals of the coil also can be connected to a connector and the testing device connects to the terminal of the connector for measuring the inductance.

The alternative of moving the accessory carrier member to a final position takes advantage of the linear relationship between inductance change and position change. In particular, the final position of the accessory support element can be determined by measuring the initial inductance of the antenna and adjusting it by the relationship inductance change per position change. This constant may be typical for any antenna of a given configuration. It is not necessary to measure the inductance of the antenna continuously during the adjustment of the position. The inductance can there be set in an open-loop manner. The stepwise adjustment can be helpful because the number of steps (clicks) can be proportional to the inductance change. Therefore, no length counter (e.g. ruler) for measuring the position change or the final position is required, simplifying the process and making it less fault-prone.

In a first embodiment of the third aspect, the measuring step and the moving step can be carried out automatically by the testing device and/or wherein the accessory carrier member carrying the dense winding section can be stepwise moved along the longitudinal axis utilizing a linear actuator comprised in the testing device.

A further aspect of the present invention relates to a vehicle, whereby the vehicle can comprise the antenna of the second aspect of the present invention (including any embodiment or a combination of embodiments thereof). Alternatively or in addition, the vehicle can comprise an antenna produced by the method for manufacturing and adjusting the inductance of an antenna as disclosed for the third aspect of the invention.

### SHORT DESCRIPTION OF THE DRAWINGS

Exemplar embodiments of the invention are disclosed in the description and illustrated by the drawings in which:

FIG. 1 illustrates an antenna according to the invention schematically.

FIG. 2 shows a variant of the antenna of FIG. 1.

FIG. 3 illustrates a detailed view of an end section of the antenna of FIG. 2.

FIGS. 4a, 4b show a sled and the sled atop a main winding carrier in an isolated view.

FIGS. 5a, 5b illustrate a sled movably engaged with the main winding carrier carrying multiple windings in a top and bottom view.

FIG. 6 shows an antenna potted in a housing.

FIG. 7 illustrates a process for manufacturing the antenna according to the invention schematically.

### EXAMPLES OF EMBODIMENTS OF THE PRESENT INVENTION

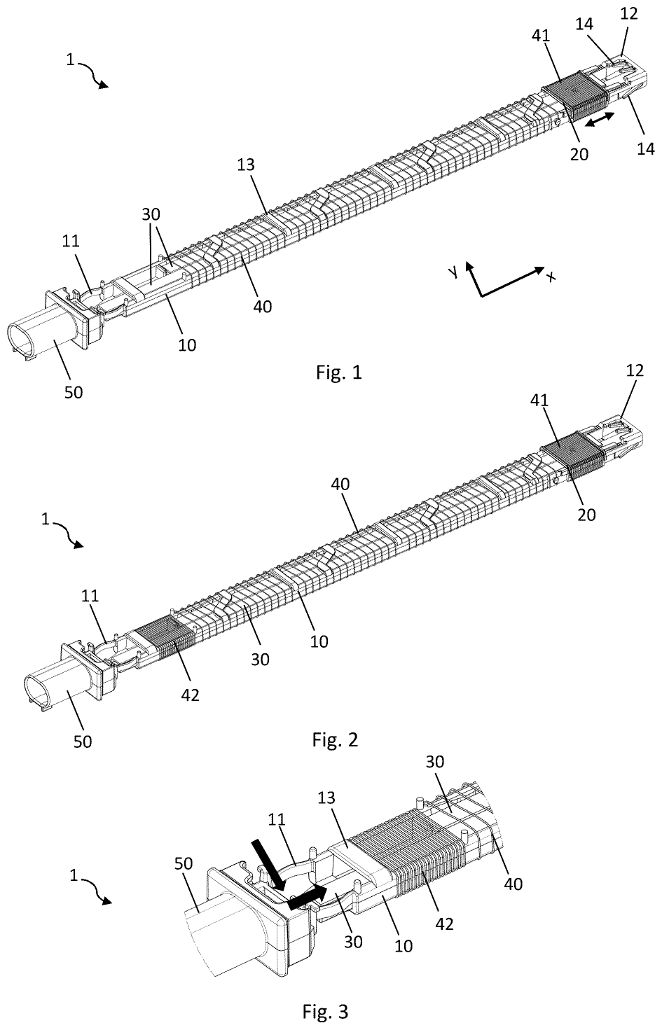

FIG. 1 illustrates an example of the antenna 1 according to the invention schematically. The antenna 1 has an elongated shape, which increases the surface for sending or receiving signals and finally extends the range of the antenna 1. The antenna 1 is designed for automotive applications, meaning it complies with all required automotive standards and is lightweight. The antenna 1 can be used for keyless entry systems, also known as smart key or keyless-go. However, the antenna 1 can also be used in different than the application as stated, such as industrial applications.

The antenna 1 comprises an elongated winding carrier featuring a main winding carrier 10 and an accessory winding carrier 20. The two carries 10, 20 are made of a thermoplastic material. However, other materials, such as glass-fibre reinforced polymer, in particular polyamide, are also possible. The elongated winding carrier is constructed axially symmetrical to a central longitudinal axis. The main winding carrier 10 comprises a first end 11 and a second end 12, whereby the accessory winding carrier 20 is located at the outermost end on the right and therefore is closer to the second end 12 than to the first end 11. The section where the accessory winding carrier 20 is placed can also be referred to as the second end section. The main winding carrier 10 as such consists of an elongated U-shaped profile with the side walls open at the top. A number of bars 13 connect the side walls and thus reinforce the structure. The bars 13 extend perpendicular to the longitudinal axis x of the elongated winding carrier. The U-shaped profile of the main winding carrier 10 reduces the weight of the antenna 1. The main carrier can be configured with small grooves at the outer edges to receive windings and fixate them.

The U-shaped profile and the bars 13 enclose an inner volume into which a plurality of ferrite cores 30 are inserted. It can be noticed that the ferrite cores 30 are arranged in two rows in the inner volume with a small air gap separating the two rows from one another. The two rows of ferrite cores 30 nearly extend from the first end 10 to the second end 12. It can be seen that a space at the second end 12 is left empty, but there are also ferrite cores 30 arranged below the accessory winding carrier 20 (which is not illustrated). The ferrite cores 30 together form a magnetic core assembly, in short a magnetic core.

The elongated winding carrier is fitted with a coil, whereby the coil is divided into two winding or coil sections. As a conductor for the coil, enamelled copper wire is used. The sparse winding section 40 is wound around the main winding carrier 10 and nearly extend along the entire longitudinal extension of the main winding carrier 10. The dense winding section 41 is wound around the accessory winding carrier 20 and, therefore only extends in the longitudinal extension of the accessory winding carrier 20. As it can be noticed, the dense winding section 41 comprises more turns per unit area, and therefore has a higher winding density compared to the sparse winding section 40. However, the number of turns of both winding sections 40, 41 can be equal or the sparse winding section 40 can have in total more turns than the dense winding section 41. Even though the sparse winding section 40 and the dense winding section 41 is illustrated as having a single layer of windings, it is possible to embody the coil with multiple layers of windings, whereby each layer can be wound into a different winding direction.

The accessory winding carrier 20 is movably engaged with the main winding carrier 10, meaning that the accessory winding carrier 20 can be moved in a limited range, between two extreme positions, along the longitudinal axis x. As the dense winding section 41 is wound around the accessory winding carrier 20, or as the dense winding section 41 is carried by the accessory winding carrier 20 the said winding section 41 can also be moved along the longitudinal axis x in the same limited range (as indicated by the double-headed arrow).

The ratio of the number of turns of the two winding sections 40, 41 to one another can be an important parameter in the design of the antenna 1. The total inductance of the antenna 1 is proportional to the permeability of the magnetic core and the total number of turns of the coil. When the coil carries a current, the coil generates a magnetic field that couples to the magnetic core. This also applies in particular to the dense winding section 41, however the magnetic field generated by this winding section 41 only couples to an end portion of the magnetic core. By moving the accessory winding carrier 20 carrying the dense winding section 41 along the longitudinal axis x, the coupling coefficient can be specifically controlled or set. The position of the dense winding section 41 relative to the second end 12 directly influences the field distribution in the magnetic core. A spread field distribution leads to low inductance. A centered field distribution leads to high inductance. Moving the dense winding section 41 closer to the center of the main winding carrier 10 will lead to a more centered field distribution and an increase in the inductance. Moving the dense winding section 41 closer to the second end will increase the spread field distribution. Any change in the position of the dense winding section 41 will directly influence the total inductance of the antenna 1. In summary, the total inductance of the antenna can be adjusted by moving the accessory winding carrier 20 carrying the dense winding section 41 along the longitudinal axis x.

The relationship between the change in inductance and the change in position is also determined, among other things, by the ratio of the number of turns of the two winding sections 40, 41 to each other. If the dense winding section 41 has more turns in relation to the sparse winding section 40, the change in inductance is greater in relation to the change in position. Furthermore, the position of the magnetic core and the amount of magnetic core material below the accessory winding carrier 20 can also influence the change in inductance. If all the parameters mentioned are optimally selected, the relationship between the change in inductance and the change in position is almost linear, which is highly desirable.

The main winding carrier 10 also includes a rim with protruding flexible spacers 14 at the second end 12. When the final assembly of the antenna 1 is inserted into a housing, the protruding flexible spacers 14 press with their end against the inner walls of the housing and thereby positioning the antenna 1 centrally within the housing. However, the flexibility of the protruding flexible spacers 14 is determined by the material used for the main winding carrier 10. Different materials can also be used for the flexible spacers 14 to set the flexibility as needed precisely.

A connector 50 is mechanically attached to the main winding carrier 10. The two terminals of the coil are connected, e.g. soldered, screwed or welded to the corresponding terminals of the connector 50. The connector 50 can be plugged into a corresponding plug connector of a control device, which may be located in the vehicle.

The coordinate system, as shown in FIG. 1, indicates the longitudinal axis x and the diagonal axis y as a basis for further explanations.

FIG. 2 shows a variant of the antenna 1 of FIG. 1. The antenna 1 as illustrated, is comparably configurated as the antenna 1 of FIG. 1, with some minor but important differences. The antenna 1 also comprises an elongated winding carrier featuring a main winding carrier 10 and an accessory winding carrier 20. The accessory winding carrier 20 is movably engaged with the main winding carrier 10 and is located at the second end 12. The main winding carrier 10 also comprises the first end 11 opposite to the second end 12, to which the connector 50 is mechanically attached. Two rows of ferrite cores 30 are also inserted into the inner volume of the elongated winding carrier.

The elongated winding carrier is fitted with a coil, whereby the coil is divided into three winding or coil sections. The sparse winding section 40 is wound around the main winding carrier 10 and is kettled by the first dense winding section 41 and the second dense winding section 42. As it can be noticed, the dense winding sections 41, 42 comprise more turns per unit area, and therefore have a higher winding density compared to the sparse winding section 40. However, the number of turns of all three winding sections 40, 41, 42 can be equal, or the sparse winding section 40 can have more turns than the total number of turns comprised in the dense winding sections 41, 42. The dense winding sections 41, 42 can have equal turns. The position of the second dense winding section 42 is fixed as no accessory winding carrier 20 movably engaged with the main winding carrier 10 is present at the first end 11. The windings of the second dense winding section 42 can be wound around the main winding carrier 10 with higher tension, such that the mechanical stability of the end section of the main winding carrier 10 is improved. On the other hand, the windings of the second dense winding section 42 prevent the ferrite cores 30 from falling out of the inner volume of the main winding carrier 10. Furthermore, the two side parts of the main winding carrier 10 are pressed against each other by the tension of the windings, which further improves the mechanical stability of the ferrite cores 30 in the main winding carrier 10. The main winding carrier 10 can also be configured to differently secure the ferrite cores 30, e.g by a dedicated fixation structure that presses against the ferrite cores 30.

In a non-illustrated example, two accessory winding carriers are present, each movably engaged with the main winding carrier 10, whereby a first accessory winding carrier is located at the position of the first dense winding section of FIG. 2 and carrying the first dense winding section. The second accessory winding carrier is located at the position of the second dense winding section of FIG. 2, and therefore carries the windings of the second dense winding section. The first and second dense winding sections can be configured with a different number of turns. The first dense winding section can be wound with more turns than the second dense winding section. Moving the first accessory winding carrier carrying the windings of the first dense winding section along the longitudinal axis can therefore lead to a greater change of the total inductance of the antenna, than moving the second accessory winding carrier carrying windings of the second dense winding section. Displacing the first accessory winding carrier can therefore be used for the course adjustment of the antenna's inductance, whereby displacing the first accessory winding carrier can be used to fine adjustment of the antenna's inductance. The sparse winding section might be equally configurated as in FIG. 2.

FIG. 3 illustrates a detailed view of the end section at the first end 11 of the antenna 1 of FIG. 2. The end section as illustrated can serve as a ferrite core inserting section, as it will be explained in the following.

The main winding carrier 10, the second dense winding section 42 and the sparse winding section 40 is illustrated. The antenna 1 also comprises the connector 50 mechanically attached to the main winding carrier 10. The U-shaped profile of the main winding carrier 10 is reinforced with the bars 13 extending perpendicular to the longitudinal axis. The antenna 1 also comprises the two rows of ferrite cores 30. If the ferrite cores 13 are designed as elongated rods, they can be inserted into the main winding carrier 10 from the first end 11 in the absence of the connector 50.

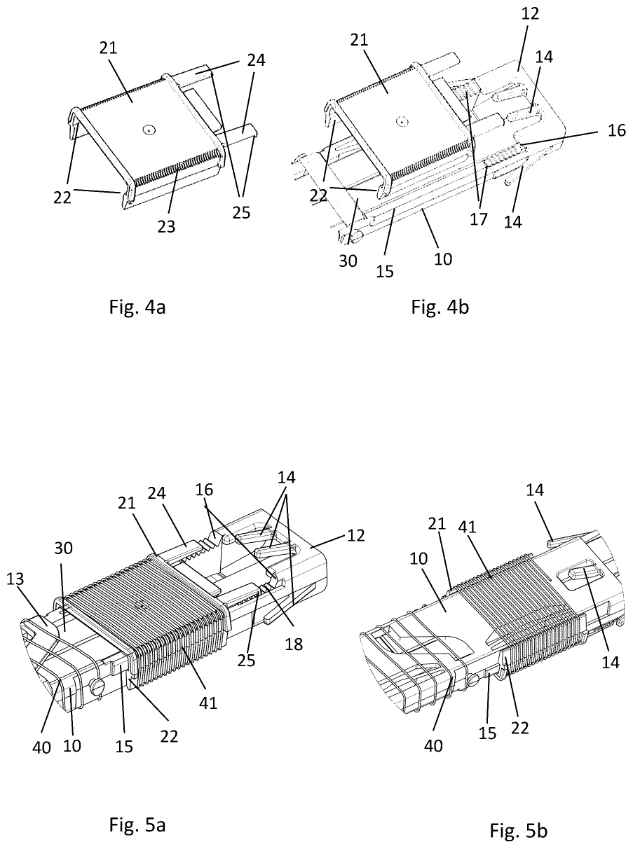

However, if the ferrite cores 30 are designed as short rods or blocks, the two rows can be formed by inserting them into the area at the connector 50 and moving them toward the second end (indicated by arrows). Alternatively, and if the coil is wound after the ferrite cores 30 have been inserted into the main winding carrier 10, the ferrite cores 30 can be inserted into the winding support through the area illustratively covered by the second dense winding section 42 and moved towards the second end. All possibilities as indicated, allow an efficient insertion of the ferrite cores 30 into the inner volume and can be suitable for producing the antenna 1 in high volumes. A further possibility for inserting the ferrite cores 30 will be explained in connection with FIG. 4b.

FIGS. 4a, 4b show a sled 21 and the sled 21 atop the main winding carrier 10 of FIGS. 1, 2 in an isolated view. The sled 21 serves as the accessory winding carrier 20 of FIGS. 1, 2.

The sled 21 as illustrated in FIG. 4a is configured with a main surface for receiving and carrying the windings of the dense winding section. Small grooves 23 can be noticed at the edges, designed to receive the windings for fixation. The sled 21 also is configurated with two guide claws 22 that can engage with a correspondingly configurated structure of the main winding carrier. Two flexible protrusions 24 extend away from the sled 21. The flexible protrusions 24 are configurated as spring members, such that they can be slightly bent but return to the initial position. Each end of the flexible protrusion 24 is formed with a projecting tooth 25.

The second end 12 of the main winding carrier 10 is illustrated in FIG. 4b. The main winding carrier 10 also comprises the flexible spacers 14 for centrally positioning the antenna in a housing. The main winding carrier 10 is configured with guiding strips 15, which protrude at the edges of the main winding carrier 10 and in which the sled 21 can engage with its guide claws 22. During manufacturing of the winding carrier, the sled 21 is snapped into the guiding strips 15, such that the guide claws 22 clasps the guiding strips 15. The sled 21 then is guided by the guiding strips 15 the guide claw 21 combinations so that it can be moved along the longitudinal axis of the main winding carrier 10. Any movement different from the movement along the longitudinal axis is prevented.

The main winding carrier 10 furthermore is configured with two toothed strips 17. When the sled 21 is snapped into the guiding strips 15, each projecting tooth 25 engages with a corresponding guiding strip 15. When sled 21 is moved, the flexible protrusions 24 are bent back until the corresponding projecting tooth 25 again engages in the directly adjacent slot of the toothed strip 17. This returns the flexible protrusions 24 to their initial position. The combination of the flexible protrusions 24, the projecting teeth 25, and the toothed strip 17 enable the sled 21 to be stepwise moved along the longitudinal axis of the main winding carrier 10. In addition, due to the flexibility of the flexible protrusions 24, the sled 21 can be fixated at a position. Even tough the sled 21 and the main winding carrier 10 comprise a pair of flexible protrusions 24 and toothed strips 17, the stepwise movement and the fixation of the sled 21 would also work when the sled 21 is configured only with one flexible protrusion 24 that engages with one corresponding toothed strip 17.

In a further non-illustrated example, the sled of FIGS. 4a, 4b is not configured with flexible protrusions 24. Instead, the guide claws comprise at least one tooth directed inwards. The main winding carrier, on the other hand, lacks the toothed strips at the position as it is illustrated in FIG. 4b. The guiding strips of the main winding carrier are equipped with columns of teeth on the sides facing outwards so that they have a dual function. By snapping the guide claws into the guiding strips, the sled is directed in movement along the longitudinal axis. The teeth of the sled inwardly directed engage with the rows of teeth of the main winding carrier, such that a stepwise movement is enabled, thereby providing the same functionality as explained in FIG. 4b.

The two rows of ferrite cores 30 are also illustrated in FIG. 4b. The main winding carrier 10 is configured with an opening (which is hidden by the sled 21). The ferrite cores 30 can be inserted into the inner volume of the main winding carrier 10 through this opening. In particular, when the ferrite cores 30 are configurated as ferrite bricks, they can be piecewise laid into this opening and pushed toward the first end (not illustrated), thereby assembling the magnetic core. The main winding carrier 10 can be configured with the said opening alternatively or in addition to the possibilities as explained for FIG. 3. After the magnetic core has been assembled, the sled 21 is engaged with the main winding carrier 10 and provides a barrier to prevent the ferrite cores 30 from falling out.

FIGS. 5a, 5b illustrate the sled 21 of FIGS. 4a, 4b engaged with the main winding carrier 10 carrying windings of the dense winding section 41 in a top and bottom view.

FIG. 5a illustrates a detailed top view of the section of the second end 12 of FIGS. 1, 2. The accessory winding carrier in the form of the sled 21 is movably engaged with the main winding carrier 10. The accessory winding carrier is wound with windings of the dense winding section 41. Two rows of ferrite cores 30 are inserted into the main winding carrier 10, and on the left a portion of the sparse winding section 40 is also illustrated. The sidewalls of the U-shaped profile of the main winding carrier 10 are reinforced with the bar 13. It can also be noticed that a plurality of flexible spacers 14 extend away from the main winding carrier 10. The main winding carrier 10 is configured with the guiding strips 15 (only one is illustrated), whereby guiding strip 15 being embraced by the corresponding guide claw 22 of the sled 21 and thence engaged. The sled 21 is held atop the main winding carrier 10 by the snap-in function. However, the windings of the dense winding section 41 also secure the position of the sled 21 atop the main winding carrier 10. It can further be noticed that the tooth 25 of each flexible protrusion 24 engages with a corresponding slot of the toothed strip 18. The step width with which the accessory winding carrier can be moved along the longitudinal axis is determined, among other things, by the width of the slot and the size of the tooth 25. These must be balanced with each other in such a way that a desired change in the inductance of the antenna is produced with each step. For limiting the movement of the sled 21 along the longitudinal axis, the main winding carrier 10 is arranged with two visible end stops 16, in the form of elevations. Suppose the sled 21 is moved towards the second end 12, the flexible projection 24 will hit the end stop to prevent further movement along the longitudinal axis. Similar configurated end stops may also be provided at the other end of the toothed strip 18. Alternatively, or additionally, the movement of the sled 21 towards the not illustrated first end, is inhibited by the bar 13 as shown.

FIG. 5b illustrates a detailed bottom view of the section of the second end 12 of FIG. 5a. The windings of the dense winding section 41 are wound around the sled 21 and the main winding carrier 10. Also, the windings of the sparse winding section 40 are wound around the main winding support 10. The guide claw 22 of the sled 21 10 embraces the guide strip of the main winding carrier 10 and therefore is movably engaged. One flexible spacer 14 is also placed at the bottom of the main winding carrier 10.

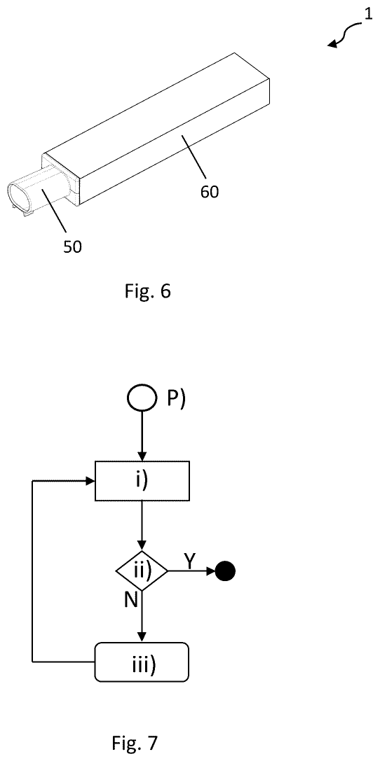

FIG. 6 shows an antenna similarly configured as illustrated in FIGS. 1, 2 potted in a housing 60. The housing 60 is made of a plastic material, for instance, the same material used for the main and accessory winding carrier. For potting, the housing 60 is filled with a predetermined amount of curable potting compound. The potting compound may be constituted of an semi-elastic material, such as silicone or urethane; or a resin material, such as acrylonitrile-butadiene-styrene, polybutylene-terephthalate, or polyphenylene sulfide. A foam rubber, such as polyurethane foam, might be used instead.

In a second step, the antenna or antenna assembly as of FIGS. 1, 2 is inserted into the housing 60 filled with the potting compound in liquid state. The opening of the housing is interlocked with the connector of the antenna, such that no moisture or dust can enter the housing 60. In a subsequent step, the antenna can be put into a vacuum chamber such that air bubbles potentially contained in the liquid potting compound are destroyed. Subsequently, the potting compound is put into a climate chamber for thermocycling the potted antenna and thereby solidifying the liquid potting compound. Instead of thermocycling, the potting compound can be solidified at room temperature. By potting the antenna, the inductance is finally set as the solidified potting compound firmly fixates all parts of the antenna, including the ferrite cores and the accessory winding carrier. Potting the antenna can be optional, as the antenna can be placed directly in a side panel of a vehicle without a dedicated housing.

FIG. 7 illustrates a process for manufacturing the antenna of FIGS. 1, 2, in particular a process for setting the inductance of the antenna. In the following it is assumed, that the antenna is finally assembled, meaning that the ferrite cores were inserted into the main winding carrier, the accessory winding carrier is engaged with the main winding carrier and moved into an initial position, which can be the position closest to the first end of the main winding carrier. It is also assumed that the coil has been wound around the winding carrier, and the terminals of the coil are connected to the connector.

In a first step P) the antenna or antenna assembly is mounted to a non-illustrated testing device. The connector is connected to the corresponding terminals of the testing device. An actuator of the testing device, which can be a linear actuator, is engaged with the accessory winding carrier. In a second step i) the coil of the antenna is energized, and the inductance of the antenna is measured. In a subsequent step ii) the measured inductance is compared with a predetermined inductance threshold. Suppose the inductance as measured corresponds to or is slightly higher than the predetermined inductance threshold. In that case, the process is terminated and the antenna can be potted as outlined in FIG. 6 or used differently. The testing device can indicate the termination of the process.

Suppose the inductance as measured is below the said predetermined inductance threshold, the actuator is activated in step iii) and the accessory winding carrier is moved one step (or on tooth) away from the initial position, preferably into a direction opposite to the first end of the main winding carrier. In the following step i) the coil of the antenna is energized, and the inductance of the antenna is measured a second time. Subsequently, in step ii), the measured inductance is compared with the predetermined inductance threshold, and if the inductance as measured corresponds to or is slightly higher than the predetermined inductance threshold, the process is terminated. If the inductance as measured is much higher than the predetermined inductance threshold, the accessory winding carrier might also be moved in the opposite direction (backward).

The steps i), ii), and iii) are repeated until the determined inductance corresponds to or is slightly higher than the predetermined inductance threshold. Thanks to the interlocking structure (toothed strip, tooth of the flexible protrusion) the position of the accessory winding carrier is secured for subsequent manufacturing 5 steps, such as the potting of the antenna. However, the position can be secured in addition by using an instant adhesive, or an adhesive tape once the testing device indicates the termination of the process.

In an alternative example, in the first step P) the antenna or antenna assembly is mounted to the testing device. The connector is connected to the corresponding terminals of the testing device. In a second step i) the coil of the antenna is energized, and the inductance of the antenna is measured. In a subsequent step ii) the measured inductance is compared to a desired inductance value. The steps that need to be taken in the stepwise adjustment of the accessory winding carrier are calculated based on the measured inductance and the desired inductance value. As mentioned hereinbefore, one step can be associated with a given change in the antenna's inductance.

The actuator is activated in step iii) and the accessory winding carrier is moved directly to the position of the desired inductance value. Instead of using an actuator, this can also be performed by manufacturing personnel simply pushing the accessory winding carrier to its final position. In summary, this releases the demand for continuously measuring the inductance, as the inductance might be set by moving the accessory winding carrier a predeterminable amount of steps. In the final step, e.g. before the position of the accessory winding carrier is fixated using adhesives, the inductance is measured a last time to ensure that it was properly set.

### REFERENCE SYMBOLS IN THE FIGURES

1 Antenna
10 Main carrier (winding carrier)
11 First end
512 Second end
13 Bars
14 Projections, flexible spacers
15 Guide strips
16, 17 End stop, protrusion
1018 Toothed strips
20 Accessory carrier (winding carrier)
21 Sled
22 Guide claws
23 Grooves
1524 Flexible protrusions
25 Nose, tooth
30 Ferrite cores
40 Sparse winding section, fixed
41 Dense winding section, displaceable
2042 Dense winding section, fixed
50 Connector
60 Housing
P) Preparation step
x Longitudinal axis
25y Diagonal axis
i) Measurement step
ii) Comparison step
iii) Adjustment step

1. A winding carrier for receiving windings of a coil and housing a magnetic core of an antenna, comprising:
a main carrier member extending along a longitudinal axis between a first end and a second end opposite the first end; and
an accessory carrier member movably engaged with the main carrier member, wherein the main carrier member and the accessory carrier member each is configured to hold a multitude of windings, wherein
the main carrier member and the accessory carrier member are configured complementary to each other for guiding a movement of the accessory carrier member along the longitudinal axis for positioning the accessory carrier member between an initial position and an end position.

2. The winding carrier of claim 1, wherein the main carrier member comprises two end sections and a middle section provided between the two end sections, wherein the accessory carrier member is positioned in one of the two end sections, wherein the end section in which the accessory carrier member is positioned is closer to the second end than to the first end.

3. The winding carrier of claim 1, wherein the main carrier member is configured with a plurality of end stops for limiting the movement of the accessory carrier member along the longitudinal axis, preferably for limiting the movement between the initial position and the end position.

4. The winding carrier of claim 1, wherein the main carrier member comprises a guiding structure, wherein the accessory carrier member is configured to embrace the main carrier member and to engage with the guiding structure for guiding the movement along the longitudinal axis and preventing the movement into a direction other than a longitudinal direction.

5. The winding carrier of claim 4, wherein the guiding structure of the main carrier member is configured as a guide strip and the part of the accessory carrier member engaging with the guiding structure is configured as guide claw.

6. The winding carrier of claim 1, wherein the accessory carrier member comprises a flexible member and the main carrier member comprises a structure complementary to the flexible member, wherein the flexible member is configured to engage with the complementary structure for stepwise position the accessory carrier member between the initial position and the end position.

7. The winding carrier of claim 6, wherein the complementary structure is configured as a toothed strip comprising a plurality of slots and the flexible member is configured as a flexible protrusion comprising a nose, wherein the nose is configured to engage with at least one slot of the plurality of a plurality of slots.

8. The winding carrier of claim 1, comprising a plurality of protruding spacers, wherein the protruding spacers are arranged at the second end for centrally positioning the winding carrier in a housing external to the winding carrier.

9. An antenna having:
a winding carrier comprising a main carrier member extending along a longitudinal axis between a first end and a second end opposite the first end and an accessory carrier member movably engaged with the main carrier member, wherein the main carrier member and the accessory carrier member each is configured to hold a multitude of windings, wherein the main carrier member and the accessory carrier member are configured complementary to each other for guiding a movement of the accessory carrier member along the longitudinal axis for positioning the accessory carrier member between an initial position and an end position,
a coil comprising a multitude of windings arranged in at least two winding sections, wherein a first winding section is wound around the main carrier member and a second winding section is wound around the accessory carrier member,
a magnetic core comprised in an inner volume of the winding carrier.

10. The antenna of claim 9, wherein the second winding section comprises more turns per unit area compared to the first winding section.

11. The antenna of claim 9, comprising a third winding section wound around the main carrier member wherein the third winding section comprises more turns per unit area compared to the first winding section.

12. The antenna of claim 10, wherein the second winding section is arranged closer to the second end of the winding carrier than to the first end and/or the third winding section is arranged closer to the first end of the winding carrier than to the second end.

13. A method for manufacturing an antenna and adjusting the inductance of the antenna, the method comprises the steps of:
providing a winding carrier comprising a main carrier member extending along a longitudinal axis between a first end and a second end opposite the first end and an accessory carrier member movably engaged with the main carrier member, wherein the main carrier member and the accessory carrier member each is configured to hold a multitude of windings, wherein the main carrier member and the accessory carrier member are configured complementary to each other for guiding a movement of the accessory carrier member along the longitudinal axis for positioning the accessory carrier member between an initial position and an end position,
inserting a magnetic core into an inner volume of the winding carrier,
forming a coil by winding a dense winding section around the accessory carrier member and winding a sparse winding section around the main carrier member, the dense section comprising more turns per unit area than the sparse section,
measuring an inductance of the assembly with a testing device;
moving the accessory carrier member along the longitudinal axis such that the inductance of the assembly matches a predetermined inductance value or inductance range.

14. The method of claim 13, wherein the measuring step and the moving step are carried out automatically by the testing device and/or wherein the accessory carrier member carrying the dense winding section is moved along the longitudinal axis utilizing a linear actuator comprised in the testing device.
